(19) United States
(12) Patent Application Publication
(10) Pub. No.: US 2025/0071708 A1
(43) Pub. Date: Feb. 27, 2025

(54) MOBILITY MANAGEMENT

(71) Applicant: Nokia Technologies Oy, Espoo (FI)

(72) Inventors: Umur KARABULUT, Munich (DE); Panagiotis SPAPIS, Munich (DE); Irina-Mihaela BALAN, Munich (DE); Bernhard WEGMANN, Holzkirchen (DE); Ahmad AWADA, Munich (DE); Martin KOLLÁR, Kosice (SK); Ugur Baran ELMALI, Munich (DE)

(21) Appl. No.: 18/811,038

(22) Filed: Aug. 21, 2024

(30) Foreign Application Priority Data
Aug. 22, 2023 (GB) 2312778.0

(51) Int. Cl. H04W 56/00; H04W 24/10

(52) U.S. Cl. CPC H04W 56/0045; H04W 24/10

(57) ABSTRACT

An apparatus configured to receive configuration information related to reporting an early timing advance, TA, acquisition, receive at least one instruction to acquire at least one TA value of at least one candidate cell, generate an early timing advance acquisition report based on the at least one TA value and on the configuration information; and transmit an indication indicative of availability of the early TA acquisition report

### FIELD

The present disclosure relates to mobility management in wireless communication networks, such as cellular communication networks.

### BACKGROUND

Cell changes in cellular communication networks are necessary to provide continuous service to user equipments, UEs, which move about within a coverage area of the network, from cell to cell or beam to beam.

Cell changes incur signalling overhead as well as interruptions in communication, as measurements are conducted in the same, and also on other, frequency as is used in communication with a serving cell.

### SUMMARY

According to some aspects, there is provided the subject-matter of the independent claims. Some embodiments are defined in the dependent claims. The scope of protection sought for various embodiments of the invention is set out by the independent claims. The embodiments, examples and features, if any, described in this specification that do not fall under the scope of the independent claims are to be interpreted as examples useful for understanding various embodiments of the invention.

According to a first aspect of the present disclosure, there is provided an apparatus comprising at least one processing core and at least one memory storing instructions that, when executed by the at least one processing core, cause the apparatus at least to receive configuration information related to reporting an early timing advance, TA, acquisition, receive at least one instruction to acquire at least one TA value of at least one candidate cell, generate an early timing advance acquisition report based on the at least one TA value and on the configuration information; and transmit an indication indicative of availability of the early TA acquisition report.

According to a second aspect of the present disclosure, there is provided an apparatus comprising at least one processing core and at least one memory storing instructions that, when executed by the at least one processing core, cause the apparatus at least to receive, via a transceiver of a user equipment, configuration information related to reporting an early timing advance, TA, acquisition, receive, from via the transceiver of the user equipment, at least one instruction to acquire at least one TA value of at least one candidate cell, generate an early timing advance acquisition report based on the at least one TA value and on the configuration information, and instruct the transceiver of the user equipment to transmit an indication indicative of availability of the early TA acquisition report.

According to a third aspect of the present disclosure, there is provided an apparatus comprising at least one processing core and at least one memory storing instructions that, when executed by the at least one processing core, cause the apparatus at least to receive at least one timing advance, TA, acquisition criterion and an early timing advance acquisition report configuration, provide to a user equipment configuration information related to reporting an early TA acquisition, wherein the configuration information includes at least one of the TA acquisition criterion or the timing advance acquisition report configuration, determine whether a TA acquisition condition is met based on the configuration information, and send at least one instruction to acquire at least one TA value of at least one candidate cell, to the user equipment.

According to a fourth aspect of the present disclosure, there is provided an apparatus comprising at least one processing core and at least one memory storing instructions that, when executed by the at least one processing core, cause the apparatus at least to prepare at least one target cell related to a user equipment served by a base station in which the apparatus is comprised, generate configuration information comprising at least one of a timing advance, TA, acquisition criterion and a TA acquisition report configuration, and provide the configuration information to a distributed unit of the base station.

According to a fifth aspect of the present disclosure, there is provided a method, comprising receiving configuration information related to reporting an early timing advance, TA, acquisition, receiving at least one instruction to acquire at least one TA value of at least one candidate cell, generating an early timing advance acquisition report based on the at least one TA value and on the configuration information, and transmitting an indication indicative of availability of the early TA acquisition report.

According to a sixth aspect of the present disclosure, there is provided a method, comprising receiving, via a transceiver of a user equipment, configuration information related to reporting an early timing advance, TA, acquisition, receiving, from via the transceiver of the user equipment, at least one instruction to acquire at least one TA value of at least one candidate cell, generating an early timing advance acquisition report based on the at least one TA value and on the configuration information, and instructing the transceiver of the user equipment to transmit an indication indicative of availability of the early TA acquisition report.

According to a seventh aspect of the present disclosure, there is provided a method, comprising receiving at least one timing advance, TA, acquisition criterion and an early timing advance acquisition report configuration, providing to a user equipment configuration information related to reporting an early TA acquisition, wherein the configuration information includes at least one of the TA acquisition criterion or the timing advance acquisition report configuration, determining whether a TA acquisition condition is met based on the configuration information, and sending at least one instruction to acquire at least one TA value of at least one candidate cell, to the user equipment.

According to an eighth aspect of the present disclosure, there is provided a method comprising preparing at least one target cell related to a user equipment served by a base station in which the apparatus is comprised, generating configuration information comprising at least one of a timing advance, TA, acquisition criterion and a TA acquisition report configuration, and providing the configuration information to a distributed unit of the base station.

According to a ninth aspect of the present disclosure, there is provided a non-transitory computer readable medium having stored thereon a set of computer readable instructions that, when executed by at least one processor, cause an apparatus to at least receive configuration information related to reporting an early timing advance, TA, acquisition, receive at least one instruction to acquire at least one TA value of at least one candidate cell, generate an early timing advance acquisition report based on the at least one TA value and on the configuration information, and transmit an indication indicative of availability of the early TA acquisition report.

According to a tenth aspect of the present disclosure, there is provided a non-transitory computer readable medium having stored thereon a set of computer readable instructions that, when executed by at least one processor, cause an apparatus to at least receive, via a transceiver of a user equipment, configuration information related to reporting an early timing advance, TA, acquisition, receive, from via the transceiver of the user equipment, at least one instruction to acquire at least one TA value of at least one candidate cell, generate an early timing advance acquisition report based on the at least one TA value and on the configuration information, and instruct the transceiver of the user equipment to transmit an indication indicative of availability of the early TA acquisition report.

According to an eleventh aspect of the present disclosure, there is provided a non-transitory computer readable medium having stored thereon a set of computer readable instructions that, when executed by at least one processor, cause an apparatus to at least receive at least one timing advance, TA, acquisition criterion and an early timing advance acquisition report configuration, provide to a user equipment configuration information related to reporting an early TA acquisition, wherein the configuration information includes at least one of the TA acquisition criterion or the timing advance acquisition report configuration, determine whether a TA acquisition condition is met based on the configuration information, and send at least one instruction to acquire at least one TA value of at least one candidate cell, to the user equipment.

According to a twelfth aspect of the present disclosure, there is provided a non-transitory computer readable medium having stored thereon a set of computer readable instructions that, when executed by at least one processor, cause an apparatus to at least prepare at least one target cell related to a user equipment served by a base station in which the apparatus is comprised, generate configuration information comprising at least one of a timing advance, TA, acquisition criterion and a TA acquisition report configuration, and provide the configuration information to a distributed unit of the base station.

According to a thirteenth aspect of the present disclosure, there is provided a method, comprising means for receiving configuration information related to reporting an early timing advance, TA, acquisition, receiving at least one instruction to acquire at least one TA value of at least one candidate cell, generating an early timing advance acquisition report based on the at least one TA value and on the configuration information, and transmitting an indication indicative of availability of the early TA acquisition report.

According to a fourteenth aspect of the present disclosure, there is provided a method, comprising means for receiving, via a transceiver of a user equipment, configuration information related to reporting an early timing advance, TA, acquisition, receiving, from via the transceiver of the user equipment, at least one instruction to acquire at least one TA value of at least one candidate cell, generating an early timing advance acquisition report based on the at least one TA value and on the configuration information, and instructing the transceiver of the user equipment to transmit an indication indicative of availability of the early TA acquisition report.

According to a fifteenth aspect of the present disclosure, there is provided a method, comprising means for receiving at least one timing advance, TA, acquisition criterion and an early timing advance acquisition report configuration, providing to a user equipment configuration information related to reporting an early TA acquisition, wherein the configuration information includes at least one of the TA acquisition criterion or the timing advance acquisition report configuration, determining whether a TA acquisition condition is met based on the configuration information, and sending at least one instruction to acquire at least one TA value of at least one candidate cell, to the user equipment.

According to a sixteenth aspect of the present disclosure, there is provided a method, comprising means for preparing at least one target cell related to a user equipment served by a base station in which the apparatus is comprised, generating configuration information comprising at least one of a timing advance, TA, acquisition criterion and a TA acquisition report configuration, and providing the configuration information to a distributed unit of the base station.

### BRIEF DESCRIPTION OF THE DRAWINGS

FIG. 1 illustrates an example system in accordance with at least some embodiments of the present invention;

FIG. 2A is a coverage map of beams in a cellular communication system;

FIG. 2B is a coverage map of beams in a cellular communication system;

FIG. 2C is a coverage map of beams in a cellular communication system;

FIG. 3 illustrates an example apparatus capable of supporting at least some embodiments of the present invention;

FIG. 4 illustrates signalling in accordance with at least some embodiments of the present invention;

FIG. 5 is a flow graph of a method in accordance with at least some embodiments of the present invention;

FIG. 6 is a flow graph of a method in accordance with at least some embodiments of the present invention;

FIG. 7 is a flow graph of a method in accordance with at least some embodiments of the present invention, and

FIG. 8 is a flow graph of a method in accordance with at least some embodiments of the present invention.

### EMBODIMENTS

Herein are described methods to enhance cell switch quality by reducing a number of unnecessary interruptions due to acquisition of timing advances to candidate cells, in a physical-layer triggered mobility process. A reporting mechanism is herein disclosed which enables the network to adapt its behaviour to contours of coverage areas of individual cells, sectors or beams in real terrain. Thus a technical effect is obtained in the form of more fluent cell changes and less unnecessary signalling, interruption and measurements.

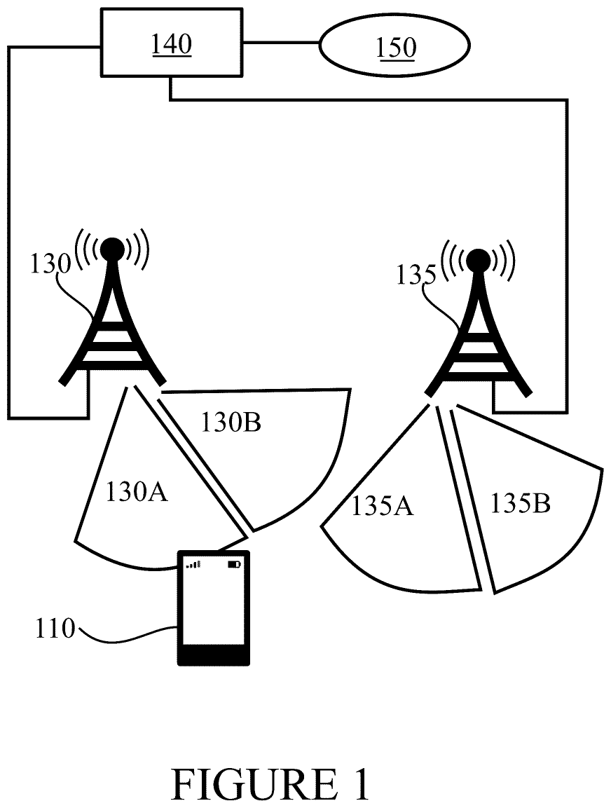

FIG. 1 illustrates an example system in accordance with at least some embodiments of the present invention. This system includes a base stations 130, 135 in communication with UEs, such as UE 110. A radio link connects base station 130 with UE 110, The radio link may be bidirectional, comprising an uplink, UL, to convey information from UE 110 toward base station 130 and a downlink, DL, to convey information from the base station 130 toward UE 110.

Base station 130 is further coupled communicatively with core network node 140, which may comprise, for example, a mobility management entity, MME, or access and mobility management function, AMF. The core network node 140 may be coupled with further core network nodes, and with a network 150, which may comprise the internet or a corporate network, for example. The system may communicate with further networks via network 150. Examples of the further core network nodes, which are not illustrated in FIG. 1 for the sake of clarity, include gateways and subscriber information repositories.

Base station 130 has plural beams 130A, 130B, of which UE 110 is in the situation illustrated in FIG. 1 attached with beam 130A, and base station 135 has plural beams 135A, 135B. The number of beams may be in excess of what is illustrated in FIG. 1. A mobility event may comprise a switch from one beam to another beam of the same cell, or a switch from one cell to another cell. To support mobility procedures, UEs, including UE 110, are configured to conduct measurements to measure signal strengths of adjacent beams and/or cells, and report results of these measurements to the network, which may then take a decision concerning a mobility event, such as a beam change or a cell switch.

Such mobility measurements at the UE side are conventionally layer-3 measurements, and the corresponding reports are layer-3, or L3, reports. Likewise a handover command from the network to a UE is typically a layer-3 message. A cell switch or beam change directed using a layer-3 command involves a reset of layers lower than layer-3, which causes delays. Layer 3 is in technology standardized by the 3^{rd} generation partnership project, 3GPP, the radio resource control, RRC, layer. Of the lower layers layer-1, or L1, is in 3GPP technology the physical layer, and layer-2, or L2, comprises the medium access control, MAC layer, radio link control, RLC, layer and packet data convergence protocol, PDCP, layer.

If mobility measurements indicate that a signal strength of a cell (or beam) the UE is currently attached with is declining and a signal strength of another cell (or beam) is increasing, then a switch to another cell (or beam) may be commanded by the network based on mobility measurement reporting from the UE.

Signalling using the RRC protocol on L3 involves delays, wherefore it would be convenient to assess the impact of UE mobility to signal strengths of signals from different beams and cells at a lower layer, such as the physical layer. A physical layer measurement may be faster to conduct, and a report of a result of such a measurement using the physical layer directly, rather than L3, may be faster to send to the network. In some cases, a physical layer report is conveyed using L1 and L2 but not L3. For example, in a distributed base station architecture, a centralized unit, CU, may act on layer-3 messages, while a distributed unit, DU, may act on the physical layer and layer-2 protocols. Thus using layer-1 and layer-2 information may be conveyed directly to a DU such that the DU is capable of acting on this information.

To reduce latencies associated with layer-3 mobility events, L1/L2 mobility enhancements may be configured in the system to enable a serving cell change via L1/L2 signaling by reducing the overhead and interruption time associated with cell switching, compared to al L3 process. For example, the network may, responsive to receiving a layer-3 mobility measurement report from the UE, configure the UE to start participating in a physical layer triggered mobility procedure. In the physical layer triggered mobility procedure, the UE synchronizes with one or more candidate cells and sends to the DU of the serving base station physical-layer measurement reports, using L1 and L2. The UE may send the physical-layer measurement reports to the DU using L1 and L2, without using L3. The physical layer measurement reports comprise indications of candidate cell signal strength, as measured in the UE. The measurement may be conducted on the physical layer, by which it is meant that the measurement does not involve using e.g. L3 filters in the UE. Also as a response to a layer-3 mobility measurement report, the serving base station may prepare the candidate cell for cell switch by providing a context of the UE to a base station which controls the candidate cell. The UE context comprises information needed to associate the UE with its active protocol connections, wherefore providing it to the candidate cell before a cell switch accelerates the cell switch process.

The DU of the serving base station may decide, based on the physical-layer measurement report received from the UE, that the UE should acquire a timing advance of the candidate cell that the physical-layer measurement reports relates to. For example, this may be the case if it appears that the UE is heading toward a cell switch to the candidate cell. A timing advance relates to a physical distance from the UE to the candidate cell base station along the radio path and is taken into account when communicating with the candidate cell base station to allow the correct propagation time for radio signals. This is useful, since cellular technologies use radio frames and slots, making it necessary for signals to arrive at the base station in their proper time slot.

The timing advance may be acquired, for example, by the UE transmitting a random access preamble in a physical random access channel, PRACH, of the candidate cell. The candidate cell may then determine the timing advance value based on timing information of the PRACH preamble as received in the candidate cell, and the candidate cell may include the timing advance in a random access response, RAR, sent to the serving cell. Thus, the determined timing advance value may be provided to the UE by the serving cell in a MAC control element, CE, for example. Alternatively, the random access response itself may be provided to the UE, enabling the UE to retrieve the timing advance value from the random access response.

Once the timing advance is acquired, the serving base station, for example the DU of the serving base station, may decide that cell switch to the candidate cell is to be made. This decision may be based on a further physical-layer measurement report from the UE, indicating that the signal strength of the candidate cell has continued to increase since the physical-layer measurement report which prompted the acquisition of the timing advance of this candidate cell. If this is the case, the serving base station, for example its DU, may instruct the UE to switch to the candidate cell, which the UE may do by performing a random access process with the candidate cell. Knowing the timing advance in advance accelerates the cell switch further, since the UE already is then partly synchronized with the candidate cell and the random access process may be skipped.

However, acquiring the timing advance to a candidate cell causes an interruption in communication between the UE and the serving cell. Uplink transmission to the serving cell needs to pause for the time the UE needs to transmit a PRACH preamble to the candidate cell, and further, as the candidate cell may operate on a different frequency, the transceiver of the UE will need to be re-tuned to the candidate-cell frequency, and then back to the serving-cell frequency. Overall, the timing gain from acquiring the timing advance before cell switch exceeds the interruption incurred from the acquiring of the timing advance, provided that too many timing advances are not acquired in advance before a single cell switch. It would thus be useful to not acquire timing advances which are not eventually used in cell switch.

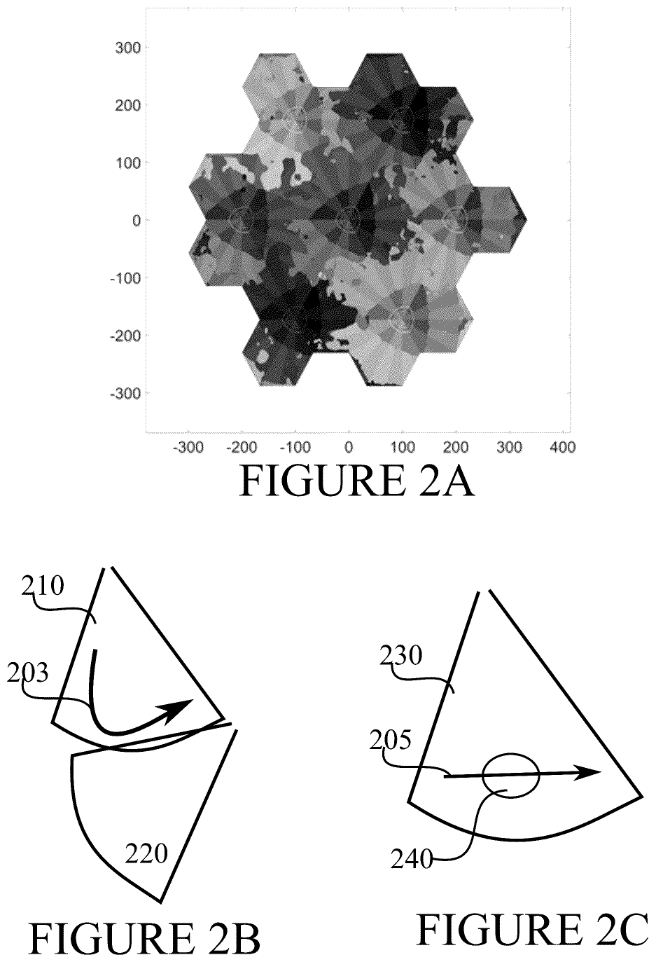

FIG. 2A is a coverage map of beams in a cellular communication system. The figure is based on real-life measurements in a 3GPP fifth generation, 5G, cellular communication system, at frequency range 2, that being 28 GHz, but the qualitative findings apply to other systems as well. In the figure, inter-base station distance is 200 metres. In detail, as can be seen in FIG. 2A, coverage may be uneven and comprise exclaves of beam coverage which are enclosed within coverage area of another beam, or another cell. These exclaves are primarily caused by shadow fading, and are more pronounced at frequency range 2 than frequency range 1 due to the higher frequencies used in frequency range 2. When a UE moves about in such an environment, it may easily occur, that it appears from a first physical-layer measurement report of candidate-cell signal strengths that the UE is approaching cell switch to a specific candidate cell, however a subsequent physical-layer measurement report from the same UE may indicate that the cell switch to the specific candidate cell is no longer likely. While this is normal behaviour, in a physical layer triggered mobility procedure it presents a challenge, since in physical layer triggered mobility, the first physical-layer measurement report may trigger the DU of the serving cell to request the UE to acquire the timing advance of the specific candidate cell. In case a subsequent physical-layer measurement report does not lead to a triggering of cell switch to the specific candidate cell, the timing advance was acquired needlessly, and the associated connection interruption was unnecessary.

FIG. 2B is a coverage map of beams in a cellular communication system. Beam 210 and beam 220 are illustrated as their schematic coverage areas. FIG. 2A shows that in practice, beam or cell coverage areas have more complex shapes than those of FIG. 2B. A trajectory 203 of a UE moving in the coverage area of beam 210 is further shown in FIG. 2B. Trajectory 203 first approaches beam 220, but turns away and remains inside the coverage area of beam 210. Thus in a physical layer triggered mobility process, it may, based on a first physical-layer measurement report, appear that cell switch to beam 220 would occur, but eventually this cell switch does not take place. Timing advance of beam 220 could be unnecessarily acquired based on the first physical-layer measurement report, obtained when the UE is moving along trajectory 203 toward beam 220.

In practice, trajectories such as trajectory 203 may be fairly frequent, or at least repeated, if there is a road with the shape of trajectory 203 in the coverage area of beam 210, for example. Another example is the case where a bus route, or tram or train track, which ferries several passengers along a route with a turn, predictably in the same location. If the network could learn, that timing advance of beam 220 is not necessary when UEs are moving along trajectory 203, communication quality could be improved by avoiding the interruption of connectivity associated with the acquisition of the timing advance of beam 220.

FIG. 2C is a coverage map of beams in a cellular communication system. Here an exclave of coverage of beam 240 is enclosed within coverage area of beam 230. Such exclaves are visible in the realistic coverage map of FIG. 2A. Trajectory 205 of a UE once more has the behaviour of approaching, and even entering, coverage area of another beam, however cell change to this cell does not occur, and acquisition of timing advance of beam 240 is unnecessary, and causes unnecessary service interruption, for a UE travelling along trajectory 205. This type of occurrence may take place if, for example, a road or track traverses exclave 240. If the network could learn that acquiring timing advance for UEs traversing trajectory 205, for example driving along a road or track, is not needed, then communication quality of these UEs could be improved, a clearly beneficial technical effect.

To enable the network to adapt its behaviour to coverage area effect such as those illustrated in FIGS. 2B and 2C, the UEs may be configured to transmit to the network timing advance acquisition reports comprising information concerning the acquiring of the timing advance values of candidate cells. The UEs may be configured to compile these reports and include data in them as a response to at least one logging criterion being determined to be fulfilled in the UE. These reports may be transmitted from the UE to the network periodically, or in connection with a layer-3 procedure, for example. The network may configure the compilation and transmission of these reports from the UE to the network, wherein the network may provide the UE the at least one logging criterion which triggers the adding of data to these reports. As an example, the network may transmit configuration information related to reporting the timing advance acquisition reports, the configuration information comprising the at least one logging criterion. The term criterion may be used with the same meaning of a condition, a trigger condition, or triggering information, etc.

The timing advance acquisition reports may be considered early timing advance acquisition reports, since they comprise information describing the acquisition of timing advance of a candidate cell, or cells, during a physical layer triggered mobility procedure before a cell switch command is issued to the UE. In some cases, the timing advance is communicated to the UE in the cell switch command, however also then the network acquires the timing advance before the cell switch command is sent to the UE, making that too an early timing advance acquisition. A timing advance acquisition report may comprise, when sent to the network, information describing plural acquisitions of timing advance values. For example, a timing advance acquisition report may comprise information describing plural acquisitions of timing advance value of a same cell. As a further example, a timing advance acquisition report may comprise information describing plural acquisitions of timing advance values, which have been logged in the report during more than one physical layer triggered mobility procedure.

In particular, the at least one logging criterion may comprise at least one of the following: the base station instructs the timing advance acquisition of the candidate cell for the first time, the base station instructs the timing advance acquisition of the candidate cell for a second time, the base station instructs the timing advance acquisition of the candidate cell for re-transmission of a physical random access channel, PRACH, preamble, the base station instructs the timing advance acquisition of a second candidate cell for the first time, the apparatus receives the timing advance of the candidate cell via a random access response from the base station, the apparatus receives the timing advance of the candidate cell via medium access control, MAC, control element, CE, during a cell switch, and the UE receives a cell switch command via MAC CE from the base station.

Concerning the last logging criterion mentioned above, the UE may receive the timing advance in a MAC CE or via a random access response, RAR, before receiving the MAC CE which carries the cell switch command. If the RAR is used, the serving base station may trigger a random access channel, RACH, process-based cell switch to any cell, to a cell that the UE has a timing advance of, or to a cell other than the one that the UE has the timing advance of. In some cases, the serving base station does not indicate a RACH type and indicates the cell switch to any cell, to a cell that the UE has the timing advance of and thus performs RACH-less cell switch to, or to a cell other than one that the UE has timing advance of, the UE then performing a RACH-based cell switch. These alternatives may serve as logging criteria, as specified by the serving base station.

It is possible to define a logging criterion to add data to the report when the UE receives the cell switch command via MAC CE from the serving base station, such that RAR is not used. In these cases, the UE may receive the timing advance in the MAC CE. In such cases, logging may be triggered in case the MAC CE does not include the timing advance, but indicates a RACH-based cell switch. Further, logging may be triggered responsive to the MAC CE not including the timing advance of the candidate cell and indicating RACH-based cell switch, but either 1) or 2) of the following: 1) the UE was triggered with timing advance acquisition of that cell before MAC CE was received, and 2) the UE has transmitted the PRACH preamble towards that candidate cell for early timing advance acquisition before MAC CE was received.

Further, logging may be triggered when the UE receives the cell switch command via MAC CE from the serving base station, such that RAR is not configured, the MAC CE command does not include the timing advance value of the candidate cell and indicates RACH based handover.

Yet further, logging may be triggered when the UE receives the cell switch command via MAC CE from the serving base station, such that RAR is not configured, the MAC CE command does not include the timing advance of the candidate cell and indicates RACH based handover but either 1) or 2): 1) the UE was triggered with timing advance acquisition of that cell before MAC CE was received, and 2) the UE has transmitted the PRACH preamble towards that candidate cell for early timing advance acquisition before MAC CE was received.

Yet further, logging may be triggered when the UE receives the cell switch command via MAC CE from the serving base station, such that RAR is not configured and the MAC CE command includes the TA of the target cell and indicates RACH-less handover.

Yet further, logging may be triggered when the UE receives the cell switch command via MAC CE from the serving base station, such that RAR is not configured and the MAC CE command includes the timing advance of the target cell and indicate RACH-less handover but either 1) or 2): 1) the UE was triggered with timing advance acquisition of another cell before MAC CE was received, and 2) the UE has transmitted the PRACH preamble towards another candidate cell for early timing advance acquisition before the MAC CE was received.

When a logging criterion is triggered and there is no existing TA acquisition report in the UE, the UE may initialize a new TA acquisition report and include therein a first data item of the newly initialized report.

Concerning the contents of the timing advance acquisition report, the UE may be configured to include in these reports at least one of the following:
a physical cell identity of the candidate cell,
a frequency of the candidate cell,
a first number indicating how many times the apparatus has been instructed to acquire the timing advance of the candidate cell,
a second number indicating how many times the apparatus has transmitted a physical random access channel, PRACH, preamble to acquire the timing advance to a beam of the candidate cell,
a plurality of physical layer measurement results of a signal strength of the candidate cell,
a random access preamble identity and beam identity that the apparatus has used to transmit PRACH preamble to the candidate cell to acquire the timing advance,
a geographic location together with time of timing advance acquisition of the candidate cell,
an identity of a method used acquisition of the timing advance of the candidate cell,
a number of times timing advance acquisition is instructed for the candidate cell, or
a number of PRACH preamble re-transmissions for acquisition of the timing advance of the candidate cell.

In some embodiments, the physical cell identity of the candidate cell and frequency of the candidate cell are both included, and further, concerning this cell, at least one of the following is included: 1) the number of times, how often the UE was triggered with early timing advance acquisition for that cell and to which beam, 2) the number of times how often the UE has transmitted the PRACH preamble for early timing advance acquisition to which beam, and 3) the UE has received the estimated timing advance via RAR or the MAC CE from the serving base station.

When the UE sends a timing advance acquisition report to the network, the network, or a self-organizing network functionality responsible for optimizing the functioning of the timing advance acquisition procedure in physical layer triggered mobility procedures, may determine whether the UE has acquired the timing advance of a wrong cell, and create a new cell-pair specific counter such as “unnecessary timing advance acquisition” which may be used for further statistical analysis. If the statistical analysis provides an indication that for certain cell neighbors the timing advance acquisition is often unnecessary, the network may initiate a re-adjustment of the parameter or trigger condition in the base station, for example in the distributed unit of the base station, for the corresponding neighbor cell which will in at least some cases prevent the acquisition of timing advance of that cell if the issue is persistent at that cell border, which enhances the sub-optimal mobility performance toward an optimal level as it will minimize the interruption experienced by the UEs due to wrong cell timing advance acquisition. Such reports may be reflected in a mobility robustness optimization, MRO, algorithm for the base station, such as the DU, and may serve as input to perform long-term optimizations to achieve better handover decisions. In particular, where the timing advance acquisition reports comprise information of UE locations, the network may discover specific locations, where acquiring timing advance of a specific candidate cell is often unnecessary. Thus the frequency at which timing advance acquisition is instructed for such UEs may be reduced from an initial baseline level. The baseline level may be a default level which has not been adjusted based on TA acquisition reports.

As discussed herein previously, a cell switch may be conducted also without the timing advance, wherefore if the network at some point suppresses, based on the timing advance acquisition reports, the acquiring of a certain timing advance, and cell change to that cell nonetheless takes place, the UE can perform a RACH process with that cell to complete the cell change.

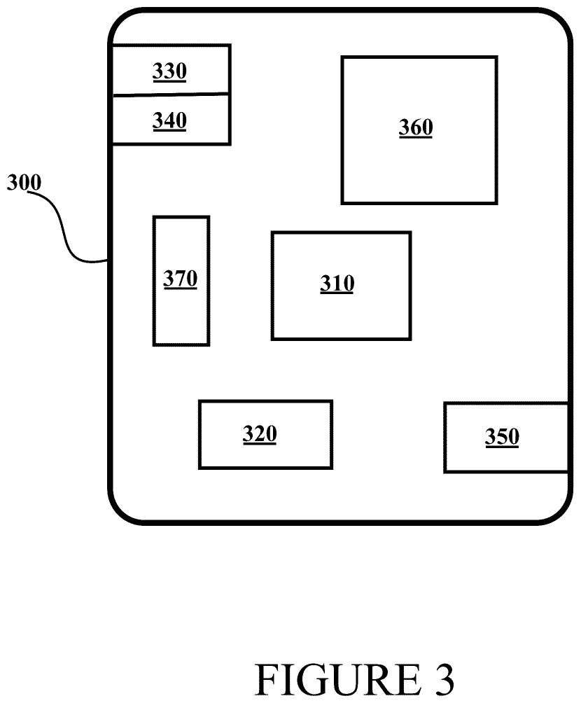

FIG. 3 illustrates an example apparatus capable of supporting at least some embodiments of the present invention. Illustrated is device 300, which may comprise, for example, a UE 110 or, in applicable parts, a base station 130 of FIG. 1. Comprised in device 300 is processor 310, which may comprise, for example, a single- or multi-core processor wherein a single-core processor comprises one processing core and a multi-core processor comprises more than one processing core. Processor 310 may comprise, in general, a control device. Processor 310 may comprise more than one processor. When processor 310 comprises more than one processor, device 300 may be a distributed device wherein processing of tasks takes place in more than one physical unit. Processor 310 may be a control device. A processing core may comprise, for example, a Cortex-A8 processing core manufactured by ARM Holdings or a Zen processing core designed by Advanced Micro Devices Corporation. A processing core or processor may be, or may comprise, at least one qubit. Processor 310 may comprise at least one Qualcomm Snapdragon and/or Intel Atom processor. Processor 310 may comprise at least one application-specific integrated circuit, ASIC. Processor 310 may comprise at least one field-programmable gate array, FPGA. Processor 310, optionally together with memory and computer instructions, may be means for performing method steps in device 300, such as processing, receiving, transmitting, sending, compiling, initializing, and determining. Processor 310 may be configured, at least in part by computer instructions, to perform actions.

A processor may comprise circuitry, or be constituted as circuitry or circuitries, the circuitry or circuitries being configured to perform phases of methods in accordance with embodiments described herein. As used in this application, the term “circuitry” may refer to one or more or all of the following: (a) hardware-only circuit implementations, such as implementations in only analogue and/or digital circuitry, and (b) combinations of hardware circuits and software, such as, as applicable: (i) a combination of analogue and/or digital hardware circuit(s) with software/firmware and (ii) any portions of hardware processor(s) with software (including digital signal processor(s)), software, and memory(ies) that work together to cause an apparatus, such as a user equipment or base station, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Device 300 may comprise memory 320. Memory 320 may comprise random-access memory and/or permanent memory. Memory 320 may comprise at least one RAM chip. Memory 320 may be a computer readable medium. Memory 320 may comprise solid-state, magnetic, optical and/or holographic memory, for example. Memory 320 may be at least in part accessible to processor 310. Memory 320 may be at least in part comprised in processor 310. Memory 320 may be means for storing information. Memory 320 may comprise computer instructions that processor 310 is configured to execute. When computer instructions configured to cause processor 310 to perform certain actions are stored in memory 320, and device 300 overall is configured to run under the direction of processor 310 using computer instructions from memory 320, processor 310 and/or its at least one processing core may be considered to be configured to perform said certain actions. Memory 320 may be at least in part comprised in processor 310. Memory 320 may be at least in part external to device 300 but accessible to device 300. Memory 320 may be transitory or non-transitory. The term “non-transitory”, as used herein, is a limitation of the medium itself (that is, tangible, not a signal) as opposed to a limitation on data storage persistency (for example, RAM vs. ROM).

Device 300 may comprise a transmitter 330. Device 300 may comprise a receiver 340. Transmitter 330 and receiver 340 may be configured to transmit and receive, respectively, information in accordance with at least one cellular or non-cellular standard. Transmitter 330 may comprise more than one transmitter. Receiver 340 may comprise more than one receiver. Transmitter 330 and/or receiver 340 may be configured to operate in accordance with global system for mobile communication, GSM, wideband code division multiple access, WCDMA, 5G, 6G, long term evolution, LTE, IS-95, wireless local area network, WLAN, Ethernet and/or worldwide interoperability for microwave access, WiMAX, standards, for example.

Device 300 may comprise a near-field communication, NFC, transceiver 350. NFC transceiver 350 may support at least one NFC technology, such as NFC, Bluetooth, Wibree or similar technologies.

Device 300 may comprise user interface, UI, 360. UI 360 may comprise at least one of a display, a keyboard, a touchscreen, a vibrator arranged to signal to a user by causing device 300 to vibrate, a speaker or a microphone. A user may be able to operate device 300 via UI 360, for example to accept incoming telephone calls, to originate telephone calls or video calls, to browse the Internet, to manage digital files stored in memory 320 or on a cloud accessible via transmitter 330 and receiver 340, or via NFC transceiver 350, and/or to play games.

Device 300 may comprise or be arranged to accept a user identity module 370. User identity module 370 may comprise, for example, a subscriber identity module, SIM, card installable in device 300 or an embedded SIM, e-SIM. A user identity module 370 may comprise information identifying a subscription of a user of device 300. A user identity module 370 may comprise cryptographic information usable to verify the identity of a user of device 300 and/or to facilitate encryption of communicated information and billing of the user of device 300 for communication effected via device 300.

Processor 310 may be furnished with a transmitter arranged to output information from processor 310, via electrical leads internal to device 300, to other devices comprised in device 300. Such a transmitter may comprise a serial bus transmitter arranged to, for example, output information via at least one electrical lead to memory 320 for storage therein. Alternatively to a serial bus, the transmitter may comprise a parallel bus transmitter. Likewise processor 310 may comprise a receiver arranged to receive information in processor 310, via electrical leads internal to device 300, from other devices comprised in device 300. Such a receiver may comprise a serial bus receiver arranged to, for example, receive information via at least one electrical lead from receiver 340 for processing in processor 310. Alternatively to a serial bus, the receiver may comprise a parallel bus receiver.

Device 300 may comprise further devices not illustrated in FIG. 3. For example, where device 300 comprises a smartphone, it may comprise at least one digital camera. Some devices 300 may comprise a back-facing camera and a front-facing camera, wherein the back-facing camera may be intended for digital photography and the front-facing camera for video telephony. Device 300 may comprise a fingerprint sensor arranged to authenticate, at least in part, a user of device 300. In some embodiments, device 300 lacks at least one device described above. For example, some devices 300 may lack a NFC transceiver 350 and/or user identity module 370.

Processor 310, memory 320, transmitter 330, receiver 340, NFC transceiver 350, UI 360 and/or user identity module 370 may be interconnected by electrical leads internal to device 300 in a multitude of different ways. For example, each of the aforementioned devices may be separately connected to a master bus internal to device 300, to allow for the devices to exchange information. However, as the skilled person will appreciate, this is only one example and depending on the embodiment various ways of interconnecting at least two of the aforementioned devices may be selected without departing from the scope of the present invention.

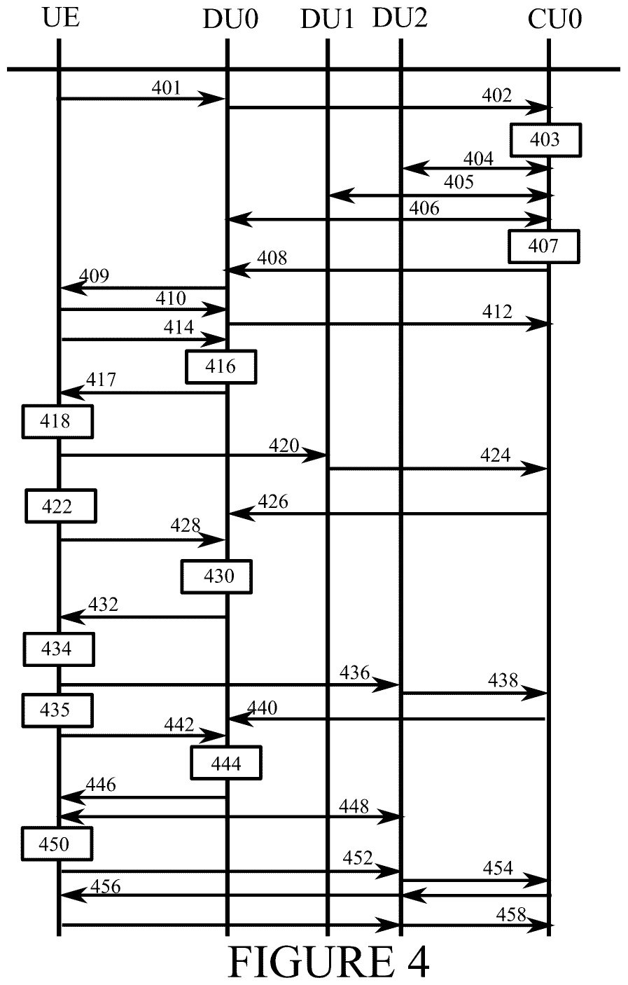

FIG. 4 illustrates signalling in accordance with at least some embodiments of the present invention. On the vertical axes are disposed, from the left, a UE, aDU0 controlling a serving cell, a DU1 controlling a cell1, a DU2 controlling cell2, and a serving CU0. As an example, the DU1 and the DU2 may connect to the same CU (e.g., CU0). Alternatively, DU1 and/or DU2 may be connected with a different CU than CU0. DU0 may be called a serving DU (or S-DU), and DU1 and DU2 may be called a target DU called as a target DU1 and a target DU2, respectively. The cell1 and the cell2 may be target cells that are some of candidate cells. Time advances from the top toward the bottom.

At first, the UE sends in phase 401 to DU0 an L3 mobility measurement report, which is transferred to the CU0 in phase 402. As a response, in phase 403, CU0 decides to prepare Cell1 and Cell2 for receiving the UE. This preparation takes place in phases 404 and 405, by the CU0 providing to these cells the UE context, discussed herein above. Further, the serving DU0 and CU0 configures the UE for a physical layer triggered mobility procedure with timing advance acquisition reporting. A UE context modification process is carried out between DU0 and CU0 in phase 406. The configuring of the UE for the physical layer triggered mobility procedure involves the CU0 generating, in phase 407, a RRC reconfiguration which comprises a measurement configuration for physical layer cell change, a configuration of prepared cells and a timing advance acquisition report configuration. The timing advance acquisition report configuration may comprise, or may indicate, one or more logging criterion to trigger the UE to include data in the timing advance acquisition report. The data the UE may include in the report has been discussed herein above, in particular, the data may comprise information on timing advance acquisitions, for example timing advance acquisitions which did not result in a cell change.

In phase 408, the CU0 provides to the DU0 an RRC message which comprises the timing advance acquisition criteria, the cell switch criteria and the timing advance acquisition report configuration. The timing advance acquisition report configuration may comprise an early timing advance acquisition report configuration. The DU0 provides in phase 409 an RRC Reconfiguration message to the UE, which comprises the timing advance acquisition report configuration and the timing advance acquisition criteria.

Additionally or alternatively, the early timing advance acquisition report configuration may be sent transparently by the DU0 in phase 408.

In phase 410, the UE acknowledges the reception of the configurations it has received to the DU0, for example in an RRC Reconfiguration Complete message. The DU0 forwards this information to CU0, in phase 412, for example as an uplink RRC message transfer message. In phase 414, the UE may perform the L1 measurement based on the measurement configuration and the early TA acquisition configuration. Then the UE transmits a physical-layer measurement report of a candidate-cell signal strength to DU0, the candidate cell being e.g. cell 1.

Responsively, in phase 416, the DU0 may determine the TA acquisition condition based on at least one of the early TA acquisition configuration or the physical-layer measurement report. Once the condition is met, then DU0 determines to instruct the UE to acquire timing advance of at least one candidate cell (e.g., cell1 and/or cell2). DU0 transmits the instruction to acquire the TA(s) to the UE in phase 417.

Phase 418 represents a possible logging criterion fulfilment determination in the UE, as a timing advance acquisition instruction concerning cell 1 is received for the first time. To acquire the timing advance of cell 1, UE transmits a PRACH preamble to DU1 in phase 420. The PRACH preamble triggers the DU1 (i.e., cell1) to transmit a RAR message comprising the timing advance to CU0, in phase 424. Then, CU0 forwards the RAR to DU0, in phase 426. The RAR may be further forwarded to the UE from DU0.

Additionally or alternatively to the exemplary embodiments, phase 422 is a second possible logging trigger fulfilment at the UE. The UE may be configured to generate the early TA acquisition report after the transmission of the PRACH preamble and then transmit the early TA acquisition report to the S-DU (i.e., DU0).

The UE may perform a measurement of candidate-cell signal strength related to the cell2 and send a second physical-layer measurement report of the candidate-cell signal strengths, in phase 428.

DU0 decides, as a response, in phase 430 that the UE is to acquire timing advance of cell 2. DU0 instructs the UE to do this in phase 432. Phase 434 represents another possible logging criterion fulfilment determination in the UE, as a timing advance acquisition instruction concerning cell 2 is received for the first time.

To acquire the timing advance of cell 2, UE transmits a PRACH preamble to DU2 in phase 436. The PRACH preamble triggers the DU2 (i.e., cell2) to transmit a RAR message comprising the timing advance to CU0, in phase 438. Then, CU0 forwards the RAR to DU0, in phase 440. The RAR may be further forwarded to the UE from DU0. DU0 may provide the RAR, or its timing advance information, to the UE, for example in a MAC CE.

Additionally or alternatively to the exemplary embodiments, the UE may be configured, in phase 435, to generate the early TA acquisition report after the transmission of the PRACH preamble to the cell2 and then transmits the early TA acquisition report to the S-DU (i.e., DU0).

In phase 442, the UE may perform the L1 or L2 measurements of candidate-cell signal strength of the cell2, then the UE transmits a physical-layer measurement report including the L1 or L2 measurements regarding the cell 2 to DU0.

As a response, in phase 444, DU0 decides to initiate cell switch of the UE to cell 2 based on the physical layer measurement reports in phase 428 and/or phase 436. Then, in phase 446, the DU0 transmits a MAC CE to the UE to trigger the cell change to cell 2. This MAC CE may comprise the timing advance of cell 2 for the UE, in particular if the RAR of phase 440 was not forwarded to the UE earlier. A random access procedure ensues in phase 448, or if the UE has timing advance of cell 2, a RACH-less cell switch may take place. In the RACH-less cell switch, the UE may directly send an RRC message to the target cell, saving the time otherwise used for a RACH process.

In phase 450, in some embodiments, the UE may decide to indicate the availability of the TA acquisition report that has been generated in previous steps. In other embodiments, the UE may decide to indicate the availability of the TA acquisition report only if the TA acquisition was triggered more than once by the S-DU/serving cell. In yet further embodiments, the UE may decide to indicate the availability of the TA acquisition report only if the TA acquisition was triggered more than once for two or more different cells by the S-DU/serving cell.

In phase 452, a RRC reconfiguration complete message is provided from the UE to DU2, to inform the network about successful completion of RRC Reconfiguration applied to handover to cell 2. This message may comprise an indication that the UE has a timing advance acquisition report that may be provided to the network.

In phase 454, DU2 indicates to CU0 that the cell switch is complete, and further, that the UE has the timing advance acquisition report ready for provision. In other words, the DU2 may forward the RRC Reconfiguration Complete message of the UE to the CU, which may include the indication of availability of the early TA acquisition report at the UE. The message of phase 454 may be an uplink RRC message transfer message, for example.

Phase 456 comprises the original serving DU0, which controls cell 0, requesting the early TA acquisition report via DU2.

In phase 458, the early TA acquisition report is provided from the UE to CU0, via DU2. The early TA acquisition report may subsequently be used in deciding by the DU0, whether to instruct further UEs to acquire timing advances of candidate cells in physical layer triggered mobility procedures.

In some embodiments, the UE is configured to receive the RAR directly from the candidate cell. In this case, the UE can obtain the timing advance of the candidate cell from the RAR, and the DU of the serving base station need not include it in the MAC CE which commands the UE to perform the cell switch.

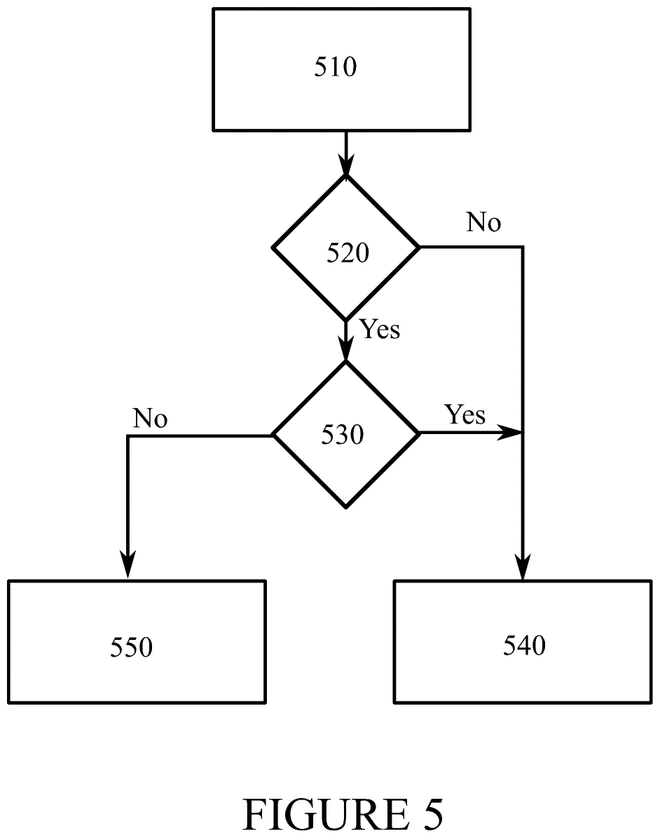

FIG. 5 is a flow graph of a method in accordance with at least some embodiments of the present invention. The method may be performed in a DU of a base station, for example, or in a control device, configured to control the functioning of a DU, when installed therein.

Processing begins in phase 510, wherein a timing advance acquisition report is received in the DU. Here a source cell of the physical layer triggered mobility procedure is cell X. Processing advances to phase 520, where it is determined, whether the UE has acquired the timing advance of cell Y. If this is the case, processing advances to phase 530, where it is determined, whether the UE changed cell to cell Y. If this is the case, processing advances to stage 540 where the decision likelihood to instruct a UE in cell X to acquire timing advance of cell Y is left unchanged. On the other hand, if in phase 520 it is determined that the UE didn't acquire the timing advance of cell Y, then the process advances directly from phase 520 to phase 540. If, in phase 530, it is determined that the UE didn't change cell to cell Y, then the process advances to stage 550, where the likelihood that a UE in cell X will be instructed to acquire timing advance of cell Y is reduced, for example by 5% or 10%.

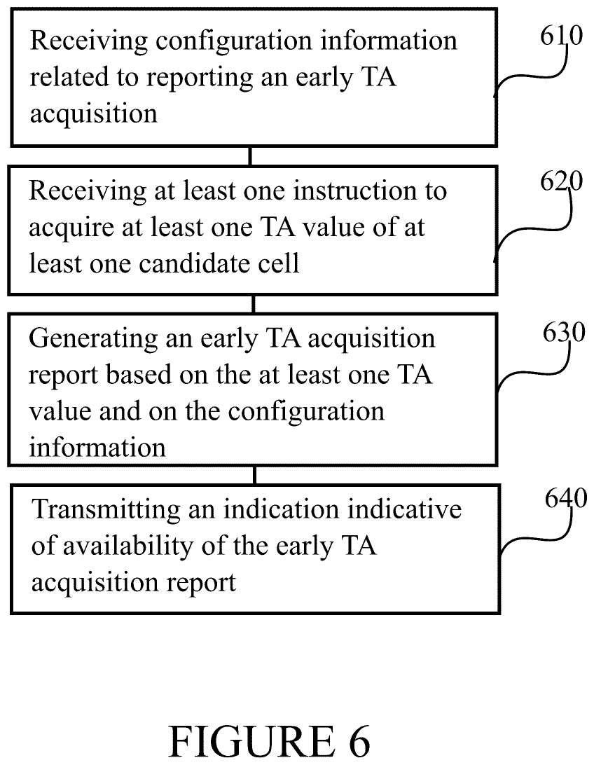

FIG. 6 is a flow graph of a method in accordance with at least some embodiments of the present invention. The phases of the illustrated method may be performed in UE 110, or in a control device configured to control the functioning thereof, when installed therein.

Phase 610 comprises receiving configuration information related to reporting an early timing advance, TA, acquisition. Phase 620 comprises receiving at least one instruction to acquire at least one TA value of at least one candidate cell. Phase 630 comprises generating an early timing advance acquisition report based on the at least one TA value and on the configuration information. Finally, phase 640 comprises transmitting an indication indicative of availability of the early TA acquisition report. The indication indicative of availability of the early TA acquisition report may indicate that the apparatus performing the method, such as a UE, has an early TA acquisition report that it may send.

In some embodiments, the method comprises including in the TA acquisition report information concerning the acquiring of the at least one timing advance value of the at least one candidate cell as a response to at least one logging criterion being fulfilled.

In some embodiments, the method comprises obtaining the at least one logging criterion from the configuration information related to reporting the early TA acquisition.

In some embodiments, the method comprises transmitting physical-layer measurement reports on a physical layer and a radio link layer in uplink direction.

In some embodiments, the method comprises compiling the physical-layer measurement reports by measuring candidate-cell signal strengths on the physical layer.

In some embodiments, the method comprises initializing the early TA acquisition report as a response to determining that one or more timing advance was acquired which did not lead to a cell switch.

In some embodiments, the method comprises providing the early TA acquisition report to a network which the apparatus is served by.

In some embodiments, the at least one logging criterion comprises at least one of the following: a reception of an instruction of the early TA acquisition of the at least one candidate cell for a first time, a reception of an instruction of the early TA acquisition of the at least one candidate cell for a second time, a reception of an instruct of the early TA acquisition of the at least one candidate cell for re-transmission of a physical random access channel, PRACH, preamble, a reception of an instruction of the early TA acquisition of a second candidate cell for a first time, a reception of the early TA acquisition of the at least one candidate cell via a random access response, a reception of the early TA acquisition of of the at least one candidate cell via a medium access control, MAC, control element, CE, during a cell switch, or a reception of a cell switch command via the MAC CE.

In some embodiments, the method comprises including in the early TA acquisition report at least one of the following a physical cell identity of the candidate cell, a frequency of the candidate cell, a first number indicating how many times the apparatus has been instructed to acquire TA value of the at least one candidate cell, a second number indicating how many times the apparatus has transmitted a physical random access channel, PRACH, preamble to acquire TA value to a beam of the at least one candidate cell, one or more of physical layer measurement results of a signal strength of the at least one candidate cell, a random access preamble identity and beam identity that the apparatus has used to transmit PRACH preamble to the at least one candidate cell to acquire TA value, a geographic location together with time of TA acquisition of the at least one candidate cell, an identity of a method used acquisition of TA value of the at least one candidate cell, a number of times for the early TA acquisition is instructed for the at least one candidate cell, or a number of PRACH preamble re-transmissions for acquisition of TA value of the at least one candidate cell.

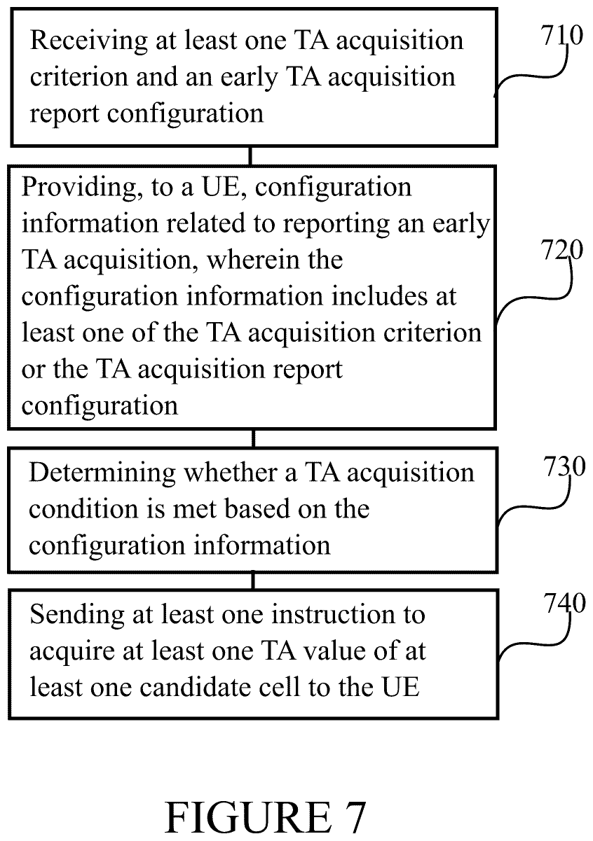

FIG. 7 is a flow graph of a method in accordance with at least some embodiments of the present invention. The phases of the illustrated method may be performed in a DU, or in a control device configured to control the functioning thereof, when installed therein.

Phase 710 comprises receiving at least one timing advance, TA, acquisition criterion and an early timing advance acquisition report configuration. Phase 720 comprises providing to a user equipment configuration information related to reporting an early TA acquisition, wherein the configuration information includes at least one of the TA acquisition criterion or the timing advance acquisition report configuration. Phase 730 comprises determining whether a TA acquisition condition is met based on the configuration information. Phase 740 comprises sending at least one instruction to acquire at least one TA value of at least one candidate cell, to the user equipment.

In some embodiments, the method comprises performing the determining whether the TA acquisition condition is met based further on plural early timing advance acquisition reports.

In some embodiments, the method comprises determining to send to further user equipments instructions to acquire the timing advance value of a specific candidate cell less frequently than a baseline as a response to the early timing advance acquisition reports indicating that timing advance values of the specific candidate cell have been repeatedly acquired by plural user equipments such that no cell switch occurred.

In some embodiments, the method comprises performing the determining to send the instructions to acquire the timing advance value of the specific candidate cell less frequently than the baseline to the further user equipments only when the further user equipments are in a geographic area that the early timing advance acquisition reports indicate is associated with plural acquisitions of the timing advance value such that no cell switch occurred.

In some embodiments, the method comprises receiving, from the user equipment, a physical layer measurement report of a candidate-cell signal strength as measured by the first user equipment.

In some embodiments, the method comprises determining, based at least in part on a second physical layer measurement report received in the apparatus from the user equipment, to instruct the user equipment to change its serving cell, and instruct the user equipment to change its serving cell.

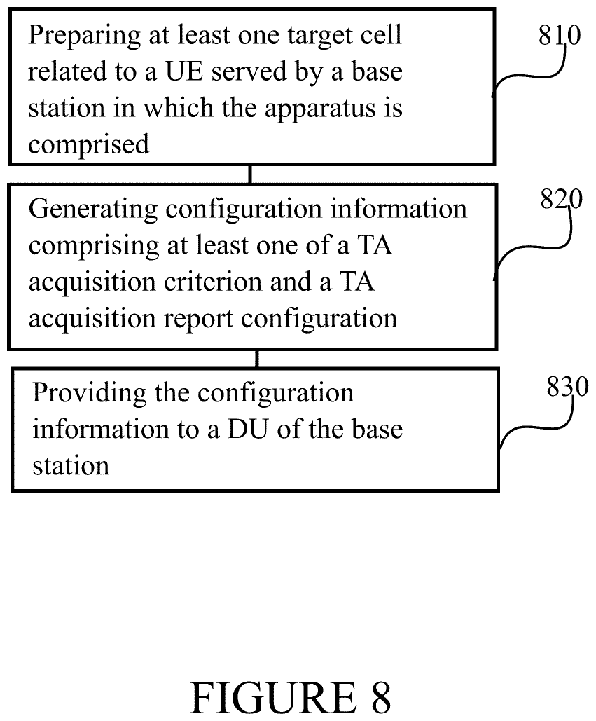

FIG. 8 is a flow graph of a method in accordance with at least some embodiments of the present invention. The phases of the illustrated method may be performed in a CU, or in a control device configured to control the functioning thereof, when installed therein.

Phase 810 comprises preparing at least one target cell related to a user equipment served by a base station in which the apparatus is comprised. Phase 820 comprises generating configuration information comprising at least one of a timing advance, TA, acquisition criterion and a TA acquisition report configuration. Phase 830 comprises providing the configuration information to a distributed unit of the base station.

In some embodiments, the method comprises receiving an indication that the user equipment has an early TA acquisition report.

In some embodiments, the method comprises requesting the early TA acquisition report from the user equipment via one of the at least one target cell, and to receive the early TA acquisition report from the user equipment.

In some embodiments of the invention, there is provided an apparatus comprising at least one processing core and at least one memory storing instructions that, when executed by the at least one processing core, cause the apparatus at least to control functioning of a user equipment, when installed in the user equipment, receive, via a transceiver of a user equipment, configuration information related to reporting an early timing advance, TA, acquisition, receive, from via the transceiver of the user equipment, at least one instruction to acquire at least one TA value of at least one candidate cell, generate an early timing advance acquisition report based on the at least one TA value and on the configuration information, and instruct the transceiver of the user equipment to transmit an indication indicative of availability of the early TA acquisition report. The apparatus may be a chipset configured to control the UE, for example.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to one embodiment or an embodiment means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment. Where reference is made to a numerical value using a term such as, for example, about or substantially, the exact numerical value is also disclosed.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the preceding description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, that is, a singular form, throughout this document does not exclude a plurality.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

### INDUSTRIAL APPLICABILITY

At least some embodiments of the present invention find industrial application in cellular networks.

### ACRONYMS LIST

3GPP 3^{rd} generation partnership project
CE control element
CU centralized unit
DU distributed unit
MAC medium access control
PDCP packet data convergence protocol
RAR random access response
RRC radio resource control
PRACH physical random access channel
RLC radio link control
TA timing advance

REFERENCE SIGNS LIST

| | |
|---|---|
| 110 | user equipment |
| 130, 135 | base station |
| 140 | core network node |
| 150 | network |
| 130A, 130B, | beams |
| 135A, 135B, | |
| 210, 220, | |
| 230, 240 | |
| 203, 205 | trajectories |
| 300-370 | structure of the device of FIG. 3 |
| 410-456 | phases of the process of FIG. 4 |
| 510-550 | phases of the process of FIG. 5 |
| 610-640 | phases of the method of FIG. 6 |
| 710-740 | phases of the method of FIG. 7 |
| 810-830 | phases of the method of FIG. 8 |

1.-42. (canceled)

43. An apparatus comprising at least one processing core and at least one memory storing instructions that, when executed by the at least one processing core, cause the apparatus at least to:
receive, via a transceiver of a user equipment, configuration information related to reporting an early timing advance, TA, acquisition;
receive, from via the transceiver of the user equipment, at least one instruction to acquire at least one TA value of at least one candidate cell;
generate an early timing advance acquisition report based on the at least one TA value and on the configuration information; and
instruct the transceiver of the user equipment to transmit an indication indicative of availability of the early TA acquisition report.

44. The apparatus according to claim 43, configured to include in the TA acquisition report information concerning the acquiring of the at least one timing advance value of the at least one candidate cell as a response to at least one logging criterion being fulfilled.

45. The apparatus according to claim 44, further configured to obtain the at least one logging criterion from the configuration information related to reporting the early TA acquisition.

46. The apparatus according to claim 43, wherein the apparatus is configured to transmit physical-layer measurement reports on a physical layer and a radio link layer in uplink direction.

47. The apparatus according to claim 46, wherein the apparatus is configured to compile the physical-layer measurement reports by measuring candidate-cell signal strengths on the physical layer.

48. The apparatus according to claim 43, wherein the apparatus is configured to initialize the early TA acquisition report as a response to determining that one or more timing advance was acquired which did not lead to a cell switch.

49. The apparatus according to claim 43, wherein the apparatus is configured to provide the early TA acquisition report to a network which the apparatus is served by.

50. The apparatus according to claim 44, wherein the at least one logging criterion comprises at least one of the following:
a reception of an instruction of the early TA acquisition of the at least one candidate cell for a first time;
a reception of an instruction of the early TA acquisition of the at least one candidate cell for a second time;
a reception of an instruct of the early TA acquisition of the at least one candidate cell for re-transmission of a physical random access channel, PRACH, preamble;
a reception of an instruction of the early TA acquisition of a second candidate cell for a first time,
a reception of the early TA acquisition of the at least one candidate cell via a random access response;
a reception of the early TA acquisition of the at least one candidate cell via a medium access control, MAC, control element, CE, during a cell switch; or
a reception of a cell switch command via the MAC CE.

51. The apparatus according to claim 43, wherein the apparatus is to include in the early TA acquisition report at least one of the following:
a physical cell identity of the candidate cell;
a frequency of the candidate cell;
a first number indicating how many times the apparatus has been instructed to acquire TA value of the at least one candidate cell;
a second number indicating how many times the apparatus has transmitted a physical random access channel, PRACH, preamble to acquire TA value to a beam of the at least one candidate cell;
one or more of physical layer measurement results of a signal strength of the at least one candidate cell;
a random access preamble identity and beam identity that the apparatus has used to transmit PRACH preamble to the at least one candidate cell to acquire TA value;
a geographic location together with time of TA acquisition of the at least one candidate cell;
an identity of a method used acquisition of TA value of the at least one candidate cell;
a number of times for the early TA acquisition is instructed for the at least one candidate cell; or
a number of PRACH preamble re-transmissions for acquisition of TA value of the at least one candidate cell.

52. An apparatus comprising at least one processing core and at least one memory storing instructions that, when executed by the at least one processing core, cause the apparatus at least to:
prepare at least one target cell related to a user equipment served by a base station in which the apparatus is located;
generate configuration information comprising at least one of a timing advance, TA, acquisition criterion and a TA acquisition report configuration, and
provide the configuration information to a distributed unit of the base station.

53. The apparatus according to claim 52, further configured to receive an indication that the user equipment has an early TA acquisition report.

54. The apparatus according to claim 53, wherein the apparatus is further configured to request the early TA acquisition report from the user equipment via one of the at least one target cell, and to receive the early TA acquisition report from the user equipment.

55. A method, comprising:
receiving, via a transceiver of a user equipment, configuration information related to reporting an early timing advance, TA, acquisition;
receiving, from via the transceiver of the user equipment, at least one instruction to acquire at least one TA value of at least one candidate cell;
generating an early timing advance acquisition report based on the at least one TA value and on the configuration information; and
instructing the transceiver of the user equipment to transmit an indication indicative of availability of the early TA acquisition report.

56. The method according to claim 55, further comprising in the TA acquisition report information concerning the acquiring of the at least one timing advance value of the at least one candidate cell as a response to at least one logging criterion being fulfilled.

57. The method according to claim 56, further comprising obtaining the at least one logging criterion from the configuration information related to reporting the early TA acquisition.

58. The method according to claim 55, wherein the method comprises transmitting physical-layer measurement reports on a physical layer and a radio link layer in uplink direction.

59. The method according to claim 58, further comprising compiling the physical-layer measurement reports by measuring candidate-cell signal strengths on the physical layer.

60. The method according to claim 55, wherein the method further comprises initializing the early TA acquisition report as a response to determining that one or more timing advance was acquired which did not lead to a cell switch.

61. The method according to claim 55, further comprising providing the early TA acquisition report to a network which the apparatus is served by.

62. The method according to claim 56, wherein the at least one logging criterion comprises at least one of the following:
a reception of an instruction of the early TA acquisition of the at least one candidate cell for a first time;
a reception of an instruction of the early TA acquisition of the at least one candidate cell for a second time;
a reception of an instruct of the early TA acquisition of the at least one candidate cell for re-transmission of a physical random access channel, PRACH, preamble;
a reception of an instruction of the early TA acquisition of a second candidate cell for a first time,
a reception of the early TA acquisition of the at least one candidate cell via a random access response;
a reception of the early TA acquisition of the at least one candidate cell via a medium access control, MAC, control element, CE, during a cell switch; or
a reception of a cell switch command via the MAC CE.
